(19) United States
(12) Patent Application Publication
(10) Pub. No.: US 2022/0408733 A1
(43) Pub. Date: Dec. 29, 2022

(54) SUNFLOWER BARK EXTRACT AND USES THEREOF

(71) Applicants: UNIVERSITEIT GENT, Gent (BE); KATHOLIEKE UNIVERSITEIT LEUVEN, Leuven (BE); INSTITUT NATIONAL POLYTECHNIQUE DE TOULOUSE, Toulouse Cedex 4 (FR); INSTITUT NATIONAL DE LA RECHERCHE AGRONOMIQUE, Paris Cedex (FR)

(72) Inventors: Danny GEELEN, Gent (BE); Philippe EVON, Séméac (FR); Bruno CAMMUE, Alsemberg (BE); Geert HAESAERT, Melle (BE); Tina KYNDT, Gent (BE); Stefaan WERBROUCK, Harelbeke (BE)

(21) Appl. No.: 17/776,823

(22) PCT Filed: Nov. 13, 2020
(86) PCT No.: PCT/EP2020/082083

§ 371 Date: May 13, 2022

(30) Foreign Application Priority Data
Nov. 15, 2019 (EP) 19209404.3

(51) Int. Cl. A01N 65/12; C05F 11/00

(52) U.S. Cl. CPC A01N 65/12; C05F 11/00

(57) ABSTRACT

The present invention relates to plant extracts and their use as biostimulant and biocontrol agent. More specific, the invention provides extracts of plants of the genus Helianthus which are capable of modifying root architecture and stimulate root development in plants. Hence, said extracts can be used to control plant development such as e.g. improve general root architecture, nutrient uptake and increase tolerance of plants to drought. In addition, these extracts can be used to control plant disease.

### FIELD OF THE INVENTION

The present invention relates to plant extracts and their use as biostimulant and biocontrol agent. More specific, the invention provides extracts of plants of the genus Helianthus which are capable of modifying root architecture and stimulate root development in plants. Hence, said extracts can be used to control plant development such as e.g. improve general root architecture, nutrient uptake and increase tolerance of plants to drought. In addition, these extracts can be used to control plant disease.

### BACKGROUND OF THE INVENTION

Biotic and abiotic stress reduces plant growth and causes up to 30% reduction in crop yield worldwide. This problem is therefore a major focus in research and development of new methods and products that mitigate yield loss. Environmental conditions that result in poor performance of plant root systems can be prevented or overcome by products that stimulate root growth. In addition, biocontrol of plant diseases is an important cornerstone in an integrated pest management, thereby aiming at reduced pesticide input.

Sunflower is widely cultivated all over the world, especially for its seeds and oils extracted therefrom. The sunflower stems, however, have no real application in agriculture, and it has been estimated that each hectare of sunflowers can produce 3-7 tons of dry biomass including stems (Marechal and Rigal, 1999). The stems are usually burnt, used as natural fertilizer, for animal feed or used for fuel production. Uses and effects of other parts of the sunflower plant are also being studied. Hashem et al., 2006, discloses preparation of high-alpha cellulose pulp from sunflower stalks. Allelopathic effects of sunflower extracts have been described by e.g. Singh et al., 2017 and Leather et al., 1983. Azania et al., 2003, reports allelopathic effects of sunflower (Helianthus annuus L.) crop residues, extracts and leachates in field studies and bioassays. Also Babu et al., 2014, mentions the presence of allelocompounds in sunflower residue, however when managed correctly said residue could improve soil organic matter dynamics and nutrient cycling, thereby creating a rather favourable environment for plant growth on long-term basis. In addition, Nisar et al., 1989, studies the effect of different types of Helianthus extracts on the development of root-knot nematodes.

The present invention provides a sunflower plant extract, in particular obtained from the bark, which has a dual function, i.e. promoting root branching/growth and triggering of the defense mechanism in the plant. The priming of defense helps the plant to establish protection against attack by pathogens, whereas stimulation of root growth is a slower response with a long lasting impact on the plant's capacity to overcome conditions of biotic and abiotic stress. In addition, plant growth is stimulated by improved assimilation of plant nutrients.

### SUMMARY OF THE INVENTION

In a first aspect, the present invention provides the use of an extract obtained from a depithed stem of a plant from the genus Helianthus, in particular Helianthus annuus L., in agriculture or horticulture.

In a particular embodiment, the present invention provides the use as defined herein, for promoting root formation in plants, comprising applying said extract on the plant or part(s) thereof, or in the growth medium of the plant.

In another particular embodiment, the present invention provides the use as defined herein for inducing and/or stimulating an immune response in a plant, more in particular for inducing resistance to biotic stress in a plant; comprising applying said extract on the plant or part(s) thereof, or in the growth medium of the plant.

In a particular embodiment, the present invention provides the use as defined herein for inducing resistance against infections by bacteria, fungi, nematodes and/or oomycetes; comprising applying said extract on the plant or part(s) thereof, or in the growth medium of the plant.

In a further embodiment, the extract as defined herein is dried or freeze-dried.

In yet a further embodiment, the extract as defined herein is applied to the leaves of a plant. Moreover, the extract may also be applied to plant seed. Consequently, the present invention further provides a plant seed coated with a coating composition comprising an extract obtained from a depithed stem of a plant from the genus Helianthus, in particular Helianthus annuus L.

In a further aspect, the present invention also provides an agricultural composition comprising an extract obtained from a depithed stem of a plant from the genus Helianthus, in particular Helianthus annuus L., and an agriculturally and/or horticulturally acceptable excipient.

In yet a further aspect, the present invention provides a process for the preparation of an extract obtained from a depithed stem of a plant from the genus Helianthus, said process comprising at least the following steps:
(a) providing stems of a plant of the genus Helianthus;
(b) separating the pith from the bark of said stems of step (a);
(c) extruding, blending or mixing the bark material obtained from step (b), optionally in the presence of a buffering agent or solvent;
(d) sieving or filtering the blend or mixture obtained from step (c); and
(e) obtaining the liquid bark extract;

wherein during said process, the temperature is raised to at least 70° C.; preferably to at least 100° C.

In a particular embodiment of the process of the present invention, the L/S (liquid/solid) ratio is between 2 and 5.

### BRIEF DESCRIPTION OF THE FIGURES

FIG. 1: Screw configuration used for the sunflower extract production through continuous aqueous extraction, using a Clextral (France) Evolum HT 53 twin-screw extruder. T2F, trapezoidal double-flight screws; C2F, conjugated double-flight screws; CF2C, conjugated cut-flight, double-flight screws with left-handed pitch (i.e., reversed pitch screws); BL22 bilobe paddles. The two numbers following the type of screw element indicate respectively the pitch and length of T2F, C2F, and CF2C screws. The two numbers following the BL22 mixing blocks represent respectively the staggering angle and length.

FIG. 2: Matter assessment of the sunflower extract production through continuous aqueous extraction, using a Clextral (France) Evolum HT 53 twin-screw extruder.

FIG. 3: Experiment workflow of root morphology bioassay.

FIG. 4: The average number of AR(A) and ARP(B) treated with different doses of sunflower bark extarct. ** means p<=0.01.

FIG. 5: Sugarcane in vitro rooting bioassay 3 weeks after incubation. On the left: explants on control non-treated medium; right: explants on medium supplemented with 100 and 1000 mg/L extract sunflower extract.

FIG. 6: Biocontrol activity of sunflower extract to control leaf spot disease on tomato caused by Alternaria alternata. Asterisks point out statistical significant differences between treatments (Dunn's test adjusted for multiple comparisons α=0.05).

FIG. 7: Biocontrol activity of sunflower extract to control late blight disease on potato caused by Phytophthora infestans. Asterisks point out statistical significant differences between treatments (Dunn's test adjusted for multiple comparisons α=0.05).

FIG. 8: Biocontrol activity of sunflower extract on AUDPC values for late blight disease in potted plants at 0-32 days after inoculation with Phytophthora infestans. Asterisks point out statistical significant differences between treatments (Dunn's test adjusted for multiple comparisons α=0.05).

FIG. 9: Biocontrol activity of sunflower extract on development of new flecks of Blumeria graminis. Asterisks point out statistical significant differences between treatments (Dunn's test adjusted for multiple comparisons α=0.05).

FIG. 10: Biocontrol activity of sunflower extract to control powdery mildew on wheat caused by Blumeria graminis. Asterisks point out statistical significant differences between treatments (Dunn's test adjusted for multiple comparisons α=0.05).

FIG. 11: Biocontrol activity of sunflower extract to control gray mold on tomato caused by Botrytis cinerea. Asterisks point out statistical significant differences between treatments (Dunn's test adjusted for multiple comparisons α=0.05).

FIG. 12: Leaf application of sunflower extract in the pathosystem canola—Botrytis cinerea. Disease severity was evaluated by measuring de lesion diameter. Bars represent average lesion diameter of 12 plants (****=p≤0.01, 1-way Anova).

FIG. 13: Leaf application of the sunflower extract in the pathosystem Arabidopsis thaliana—Hyaloperonospora arabidopsidis. Disease severity was evaluated by quantifying the amount of newly produced pathogen spores on batches of 15 plants. Bars represent average spore formation of 7 batches (each representing 15 plants (****=p≤0.01, 1-way Anova).

FIG. 14: Induced systemic resistance triggered by leaf application of the sunflower extract in the pathosystem Arabidopsis thalinana—Pseudomonas syringae. Each time-point represents mean (±SEM) of 5 leave samples consisting of 4 pooled leaf disks of 2 independent replicate plants. (*=p≤0.05, **=p≤0.01, 1-way Anova at the different time-points).

FIG. 15: Systemic defense activation effect in rice versus root-knot nematodes after foliar application of sunflower extract. Inoculation with 250 second stage juveniles of root-knot nematode Meloidogyne graminicola on the root system was done at 24 h after foliar application of the extract or water-sprayed control plants. Data was taken 2 weeks later. (a) Shoot height, (b) root length, (c) number of galls per rice plant. Bars show the average±Standard error of 6 plants per treatment. *: statistically different from water-sprayed control plants (Duncan test; p<0.05).

FIG. 16: Direct effect of sunflower extract on the growth of Botrytis cinerea. Vertical lines indicate standard deviations. For the other bars, the SD was equal to 0. There were no significant differences in growth between control and sunflower extract treatments at any time point.

### DETAILED DESCRIPTION OF THE INVENTION

As used herein, the singular forms “a”, “an”, and “the” include both singular and plural referents unless the context clearly dictates otherwise. The terms “comprising”, “comprises” and “comprised of” as used herein are synonymous with “including”, “includes” or “containing”, “contains”, and are inclusive or open-ended and do not exclude additional, non-recited members, elements or method steps. The term “about” as used herein when referring to a measurable value such as a parameter, an amount, a temporal duration, and the like, is meant to encompass variations of +/−20% or less, preferably +1-10% or less, more preferably +/−5% or less, of and from the specified value, insofar such variations are appropriate to perform in the disclosed invention. It is to be understood that the value to which the modifier “about” refers is itself also specifically, and preferably, disclosed. Whereas the terms “one or more” or “at least one”, such as one or more or at least one member(s) of a group of members, is clear per se, by means of further exemplification, the term encompasses inter alia a reference to any one of said members, or to any two or more of said members, such as, e.g., any >3, >4, >5, >6 or >7 etc. of said members, and up to all said members. All references, and teachings specifically referred to, cited in the present specification are hereby incorporated by reference in their entirety. Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention. In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous. Reference throughout this specification to “one embodiment” or “an embodiment” means that a particular feature, structure or characteristic described in connection with the embodiment is included in at least one embodiment of the present invention.

The present invention provides a plant extract and its use as a biostimulant and/or biocontrol agent. In one embodiment, such as its use as biostimulant, the extract is capable of modifying the root architecture of plants, in particular the stimulation of root branching and root growth. In another embodiment, such as its use as biocontrol agent, the extract is capable of triggering a defense mechanism in plants establishing protection against plant pathogens, such as by inducing and/or stimulating an immune response in said plants.

The extract of the present invention is an extract obtained from a plant of the genus Helianthus. Helianthus or sunflower is a genus of plants comprising about 70 different species. In a specific embodiment, the extract is obtained from the sunflower plant Helianthus annuus L., in particular from a part of said plant such as the stem, more specific from the bark. Sunflower bark is considered as a by-product from sunflower cultivation and stem fibre extraction. A sunflower stem is composed of pith in the center and bark in the periphery. In one embodiment, the sunflower extract is an extract from the bark of the stem of the sunflower (genus Helianthus). In said embodiment, the bark is mainly or completely separated from the pith (referred to herein as “depithed stem”). This can for example by done by stripping the bark from the stem, manually, mechanically or in any other way.

In general, plant extraction is a process that aims to extract certain components present in plants, into an extraction solvent or buffer. In the present invention, said plant extraction process is a solid/liquid separation operation. During said operation the plant or a part(s) thereof may be placed in contact with a fluid or a gas (water vapor or supercritical fluids), referred to as the (extraction) solvent or buffer. The plant components of interest are then solubilized and contained within the solvent or buffer; thereby obtaining the “plant extract”. Subsequently, the obtained plant extract can be sieved (e.g. with mesh size ranging from 50 μm, 100 μm, 200 μm, 300 μm, 400 μm or 500 μm to 1 mm, 1.5 mm or 2 mm; in particular between 500 μm and 1.5 mm) and optionally a further excipient or diluent can be added. After extraction, the solvent or buffer can optionally be eliminated to obtain a dry extract (e.g. by drying, freeze-drying or lyophilization). In a particular embodiment of the present invention, the extract is a crude extract.

Different types of extraction methods are suitable within the context of the present invention, as known to the skilled person. In one embodiment, sunflower stems are collected (e.g. from the field) and the bark is stripped or separated (e.g. mechanically) from the main stem, producing isolated bark and isolated sunflower pith (that can further be used as a source for e.g. bio-based insulating materials). The depithed sunflower stem, referred to herein as “bark”, is either pressed, blended, mixed or grinded with a solvent (e.g. water) resulting in a pulp. In a particular embodiment the obtained pulp is filtered or sieved once or multiple times, such as twice, to remove suspended or larger particles. The filtered supernatant or filtrate is the extract of the invention. Optionally, the filtered supernatant is centrifuged to form a pellet of suspended particles that were not removed during the filtering step(s). The supernatant is separated from this pellet and used as plant extract in liquid form. In the alternative, the bark is extruded using a solvent (e.g. water) resulting in an extrudate and filtrate. The obtained filtrate is the extract of the invention. In an optional step the solvent is evaporated. Optional dilution or concentration of the obtained extract can be done as mentioned herein.

In one embodiment of the present invention, the extraction process is performed using a stirred batch reactor. In another embodiment, the extraction is performed using a twin-screw reactor, in particular a thermo-mechano-chemical twin-screw reactor. This process generates in a single step and in a continuous mode an extract containing bioactive molecules from bark which is the source in the present invention used for biostimulant and/or biocontrol agent production. Optionally, the pulp, liquid or filtrate is further processed to ensure the quality of the extract, such as a centrifugation step to remove small solid particles through filtering using a sieve, and/or freeze-drying for storage and transport purposes.

The solvent used in the method of producing the plant extract is preferably selected from a group consisting of ethanol, methanol, water, alkaline solutions having a pH up to 12 (e.g. soda or potash) and any suitable buffer such as e.g. a water-based buffer having a pH range between 5 and 8 (e.g. Na phosphate buffer, K phosphate buffer, Tris buffer, phosphate buffered saline, or a borate buffered saline), including combinations thereof. In a particular embodiment, the solvent is water. In said embodiment, only water is used during the extraction process and no other types of solvents.

In one embodiment, the obtained extract is diluted, such as e.g. by adding the same solvent that was used during the extraction step, i.e. mixed with water or another solvent to form the plant extract. Hence, the plant extract is a liquid extract or a liquid formulation.

In a further embodiment, the obtained extract is concentrated, for instance by evaporation of a portion of the solvent, to form the plant extract of the invention.

In one embodiment, the invention provides a process for the preparation of an extract obtained from a depithed stem of a plant from the genus Helianthus, said process comprising at least the following steps:
(a) providing stems of a plant of the genus Helianthus;
(b) separating the pith from the bark, such as by stripping the bark from the stem;
(c) extruding, blending or mixing the bark material provided under (b), optionally in the presence of a buffering agent or solvent, in particular water;
(d)isolating the liquid fraction obtained from step (c); and
(e) obtaining said extract;

wherein during the process, the temperature is preferably raised to at least 70° C.; more preferably to at least 100° C.

Optionally a surfactant or other excipient defined herein can be added in step c or e.

In a specific embodiment, the extraction process uses a twin-screw reactor e.g. with successive modules. Said process essentially comprises the following steps:
(a) feeding of the bark material into the extruder inlet port;
(b) conveying of the bark material using screws preferably having a progressive decrease in pitch;
(c) injection of the buffering agent or solvent, in particular water;
(d) mixing the bark material and the buffering agent or solvent;
(e) separating the liquid (i.e., the filtrate or extract) and solid (i.e., the extrudate) phases by filtration;
(f) obtaining the bark extract;

wherein during the process, the temperature is preferably raised to at least 70° C.; more preferably to at least 100° C.

In one embodiment, the invention relates to an extract obtained by the process as defined herein.

Extraction parameters, such as screw profile, temperature profile, screw rotation speed, and flow rates of both bark and solvent can be adapted by the skilled person to optimize extraction efficiency and conservation of bioactivities. In one embodiment, the extruder screw speed in said process is between 100 and 400 rpm, in particular between 200 and 300 rpm. In a further embodiment, the liquid/solid (L/S) ratio is between 2 and 5, in particular between 2.5 and 4.5, more in particular between 2.75 and 3.5.

In one embodiment, the twin-screw extrusion process is performed without use of a grinding zone, and/or in the pressing zone, where the liquid/solid separation takes place (last module of the barrel), reverse-pitch elements (or counter-threads) are used such as a single pair of CF2C reverse-pitch elements (double-flight counter-threaded elements).

In a particular embodiment of the invention, the extrusion or process temperature ranges from 10 to 150° C., and is preferably raised to at least 70° C., 80° C., 90° C. or 100° C. in the course of the process. This can for example be achieved, by applying different temperatures in the different modules of the extruder, such as 20-30° C. in module 1, 70-90° C. in module 2, 90-110° C. in modules 3 to 6, and 100-120° C. in module 8. In particular, the temperature is raised to about 90-110° C., more in particular to about 95-105° C., even more in particular to about 100° C., in the extraction zone (modules 3 to 6 in the twin-screw reactor of the present examples), which temperatures are preferred for optimizing the extraction efficiency.

In one embodiment, a temperature of at least and about 100° C. is applied along the extruder barrel (optionally ranging up to about 110° C. in the pressing zone).

The plant extract of the embodiments can be used, optionally in diluted or concentrated form, directly in the various methods to be further disclosed herein. Alternatively, the plant extract is used to form a (agricultural or horticultural or arboricultural) composition or formulation as provided herein.

It has been demonstrated in the present invention that the sunflower bark extract provided herein when applied on or to a plant, promotes root branching and/or significantly induces the formation of roots, in particular of adventitious roots (AR) (such as e.g. on the hypocotyl). The applying step could be performed according to various embodiments provided herein. For instance, the plant extract or composition comprising it could be sprayed on the plant, watered on the plant, added to the substrate, such as hydroponics, soil, peat, compost, vermiculite, perlite, sand or clay, in which the plant is growing, etc. In a particular embodiment, the extract of the invention is applied on the leaves of the plant, e.g. by spraying. In addition, the extract can be applied as a seed coating.

In one embodiment, the extract of the invention is used for modulating plant development and in particular for promoting root branching and/or the growth of adventitious roots (including increase in AR root number) and/or the growth of root hairs in plants, this when compared to untreated plants. Hence, the extract can be used as a biostimulant, more specific in a method to control plant development such as e.g. increasing the tolerance of plants to stress (e.g. drought stress, heat stress, cold stress, salt stress), or to control physiological phenomena such as pre-harvest sprouting and premature senescence. In certain embodiments, the plant with altered root morphology exhibits improved tolerance to stress conditions selected from the group consisting of drought, flooding, high salt growth conditions, extreme cold, and (extreme) heat, compared to the average tolerance of a statistically significant control population that has not been treated with the extract.

The term ‘plant development’ is defined by the growth of a plant through cell division and cell expansion. These processes occur in a coordinated and organized manner within meristems at certain locations in the plant body. Meristems generate new organs be it in the root or the shoot part of the plant. The control of cell division and expansion in meristems determines the architecture of a plant. Plant development also encompasses the transition of one ontogenic state to another such as for example the vegetative phase to the regenerative phase. The term ‘modulate’ means to change, to regulate, to influence and/or to adjust plant development. The term ‘adventitious root growth’ refers to the expansion of the root biomass mediated by cell division and cell expansion in the adventitious root meristems.

In a further embodiment, the sunflower bark extract of the present invention is used in a method of inducing (systemic) resistance to biotic stress in a plant. The method comprises applying the plant extract and/or composition to the plant, after which systemic plant immunity will be activated. In the present invention, expression of resistance-related markers was determined and elevated expression of pathogenesis-related protein 1 (PR1) and plant-defensin 1.2 (PDF1.2) (was detected using standard methods (such as qPCR). The applying step could be performed according to various embodiments. For instance, the plant extract or composition could be sprayed on the plant, watered on the plant, added to the substrate, such as hydroponics, soil, peat, compost, vermiculite, perlite, sand or clay, in which the plant is growing, etc. In the alternative, the extract can be used as a seed coating.

Hence, the current invention provides a method of treating or preventing, or at least inhibiting or alleviating, pathogen or pest damage in a plant, in particular through the activation of the plant defense mechanism. The plant extract is able to achieve this protecting effect in the whole plant even when sprayed only on a part of the plant, or when sprayed at relatively low concentrations, and without being directly toxic to said plant pathogen. Of particular advantage is that the present plant extract can be used pre-emptively (e.g. to seedlings or non-infected plants or plants having no visible signs of infection) and require only a simple formulation. The use as a priming agent will delay, or even prevent the damage to the plant when infected.

The present invention relates to methods and compositions which can be used to stimulate or induce plant defense and/or immune responses against plant pathogens, in particular against bacteria, fungi, nematodes and oomycetes. In one embodiment, the invention provides a method for controlling plant pathogens, such as bacteria, fungi, nematodes and oomycetes, said method comprising applying on or to said plant an extract of the stem, in particular the bark, of a plant of the genus Helianthus.

Examples of phytopathogenic bacteria include the genera Pseudomonas, Ralstonia, Rhizobium, Agrobacterium, Xanthomonas, Erwinia, Xyllela, Dickeya, Pectobacterium, Streptomyces, Clavibacter, Candidatus Liberibacter, Bacillus, Corynebacterium and Burkholderia. In one embodiment, the invention provides a method to reduce and/or prevent infection of a plant with the phytopathogenic bacterium Pseudomonas.

Examples of phytopathogenic fungi (including biotrophic, hemi-biotrophic, necrotrophic fungi) include the genera Magnaporthe, Botrytis, Puccinia, Fusarium, Blumeria, Mycosphaerella, Colletotrichum, Ustilago, Phakopsora, Alternaria, Sclerotinia, Cladosporium and Rhizoctonia. In one embodiment, the invention provides a method to reduce and/or prevent infection of a plant with the phytopathogen Phytophthora infestans (late blight of potato), Botrytis cinerea (gray mold of tomato), Blumeria graminis (powdery mildew of wheat) and Alternaria alternata (leaf spot of tomato).

Examples of plant parasitic nematodes include “cyst nematodes” (genera Heterodera and Globodera) and “root-knot nematodes” (genus Meloidogyne). Examples of cyst nematodes include, H. schachtii (sugar beet cyst nematode), H. avenae (cereal cyst nematodes), H. glycines (soybean cyst nematode), H. sacchari (sugarcane cyst nematode), H. carotae (carrot cyst nematode), G. pallida (white potato cyst nematode) and G. rostochiensis (yellow potato cyst nematode). Root-knot nematodes include, for example, M. graminicola, M. javanica, M. incognita, M. arenaria, M. chitwoodi, M. artiellia, M. fallax, M. hapla, M. microtyla, M. partityla, M. panyuensis, M. naasi, M. exigua, M. enterolobii and M. paranaensis. Other nematodes that cause significant damage include the “root-lesion” nematodes such as Pratylenchus, particularly P. penetrans, which infects maize, rice and vegetables, P. brachyurus which infects pineapple, P. zeae, which infects cereals, sugarcande and coffee, P. coffeae, which infects coffee and banana, and P. thornei, which infects wheat.

In one aspect, “plant parasitic nematodes” include microorganisms from the genera Meloidogyne, Heterodera, Globodera, Pratylenchus, Aphelenchoides, Xiphinema, Radopholus, Bursaphelenchus, Rotylenchulus, Nacobbus, Longidorus, Ditylenchus and Trichodorus, and in particular from the genera Meloidogyne, Heterodera and Pratylenchus.

In one embodiment, the invention provides a method to reduce and/or prevent infection of a plant with the phytopathogen Meloidogyne.

Examples of phytopathogenic oomycetes (formerly classified as fungi) are species of the genera Pythium, Phytophtora and Peronosporaceae (e.g. Hyaloperonospora), in particular Phytophtora and Peronosporaceae. Pythium-induced root rot is a common crop disease.

By acting via the plant, the extracts of the present invention, have a minimal impact on beneficial soil organisms, thereby making them more suitable crop protection agents. The present invention generally relates to a sunflower extract as provided herein that can be used as biological control agent for local and systemic defense activation against biotic stresses, such as various plant pathogens. The sunflower extract can be used to stimulate the defenses of a plant by inducing its resistance to such biotic stresses in a systemic way. Systemic effects are defined as those effects occurring in tissues distant from the site of contact. The plant extract can also be used to prevent or treat, or at least inhibit or alleviate, plant diseases.

The present invention also encompasses (the use of) a composition or formulation comprising the sunflower extract of the invention. An “agrochemical composition” as used herein means a composition for agrochemical use, such as use in the agrochemical industry, including agriculture, horticulture, floriculture, arboriculture and home and garden uses for stimulating plant/root growth and/or for protecting plants or parts of plants, crops, bulbs, tubers, fruits (e.g. from harmful organisms, diseases or pests) as herein defined, comprising at least the extract as defined herein, and at least one agriculturally and/or horticulturally acceptable excipient. Said composition may optionally be supplemented with one or more additives favoring optimal dispersion, atomization, deposition, leaf wetting, distribution, retention and/or uptake of the active compound(s). Typically such composition or formulation further comprises at least one additional component or excipient such as a surfactant, a (solid or liquid) diluent and/or an emulsion stabilizer, which serves as a carrier. The (agrochemical) formulation generally comprises between 1 and 99.9%, between 5 and 99%, between 10 and 99%, or between 20 and 90% by weight of the plant extract. The concentration of the excipient in the agrochemical formulation generally ranges from 1 to 50% by weight. With “surfactant” is meant herein a compound that lowers the surface tension of a liquid, allowing easier spreading. The term “penetration enhancer” is understood herein as a compound that accelerates the uptake of active ingredient through the cuticle of a plant into the plant, i.e. the rate of uptake, and/or increases the amount of active ingredient absorbed into the plant. With “dispersing agent” is meant a substance added to a suspension, usually a colloid, to improve the separation of particles and to prevent settling or clumping. The term “emulsifier” as used herein refers to a substance that stabilizes an emulsion, i.e. a mixture of two or more liquids. Examples of suitable excipients are Tween® 20, which essentially comprises polyoxyethylene (20) sorbitan monolaurate (polysorbate 20), castor oil ethoxylate, rapeseed methyl ester, alkyl phosphates, tributyl phosphate, tripropyl phosphate, naphthalene sulphonic acid salts, organic sulfonate/2-methylpentane-2,4-diol, alkylpolyglucoside, siloxanes derivates, alkylsulfonates, polycarboxylates, lignosulfonates, alkoxylated triglycerides, fatty amines polymers, and dioctylsulfosuccinates.

An additive, a plant (micro) nutrient, a buffer, a crop oil, a drift inhibitor and/or an (inert) substratum can also be part of the composition or formulation. Typically the extract of the invention may be administered to a plant in a suitable agriculturally acceptable formulation, including but not limited to, a growing medium such as soil or hydroponic liquid medium, dusts, granules, solution concentrates, emulsifiable concentrates and wettable powders. The term “agriculturally acceptable” indicates that the formulation is non-toxic and otherwise acceptable for application to a plant, whether applied indoors (e.g. in a contained environment) or outdoors (e.g. in a non-contained environment that is exposed to other plant, animal and human life).

Sprayable formulations are typically extended in a suitable medium before spraying. Such liquid and solid formulations are formulated to be readily diluted in the spray medium, usually water, but occasionally another suitable medium like an aromatic or paraffinic hydrocarbon or vegetable oil. Spray volumes can range from about one to several thousand liters per hectare, but more typically are in the range from about ten to several hundred liters per hectare. Sprayable formulations can be tank mixed with water or another suitable medium for foliar treatment by aerial or ground application, or for application to the growing medium of the plant. Liquid and dry formulations can be metered directly into drip irrigation systems or metered into the furrow during planting.

The composition or formulation will typically contain effective amounts of the sunflower extract as described herein. An “effective amount” means that it is used in a quantity which allows to obtain the desired effect but which does not give rise to any significant phytotoxic symptom on the treated plant. In one embodiment, the concentration of the extract administered on or to the plant ranges from 0.01 g/l (0.01 g dry weight raw or source material/1l buffer/solvent) to 100 g/l (100 g dry weight raw or source material/1l buffer), in particular from about 0.01 g/l to about 50 g/l; from about 0.01 g/l to about 20 g/l; from about 0.01 g/l to about 10 g/l; from about 0.01 g/l to about 5 g/l; from about 0.03 g/l to about 3 g/l.

The present invention in particular provides the use of the extracts as defined herein in agriculture and/or horticulture; more in particular in crop production. In the context of the present invention, the term “agriculture” is meant to be the cultivating of plants with the purpose of producing food, feed, and other desired products obtained from the cultivation of plants; including large-scale crop production. In the context of the present invention, the term “horticulture” is meant to be the cultivation of plants such as for foods or materials; specifically, it is meant to be the growing of flowers, fruits, and vegetables. It also includes arboriculture, which is meant to be the cultivation of trees, shrubs, vines and other kinds of woody plants.

According to the method of the present invention, the extract or composition according to the invention can be applied once to a plant (part)/crop, or it can be applied two or more times after each other with an interval between every two applications as can be determined by the person skilled in the art.

Any plant/crop can be treated. The term “plant (or plants)” is a synonym of the term “crop” which is to be understood as a plant of economic importance and/or a men-grown plant. The methods, extracts and compositions of the present invention may be applied to any monocot or dicot plant or a tree.

In a further embodiment of the present invention, the extract or a composition comprising the extract is applied to a plant, directly or indirectly. Any appropriate plant part can be treated or used including plant organs (e.g., leaves, stems, roots, etc.), seeds, and plant cells and progeny of the same. In the alternative, the extract or composition can be applied to the soil surrounding the plant, however with direct contact with the roots. The applying of the extract is prior to planting, at planting, or after planting. In one embodiment, contacting includes direct application to a plant. All or part of a plant including, without limitation, leaves, stems, roots, propagules (e.g., cuttings), fruit, seeds etc., may be contacted with the extract described herein. Contacting may also be carried out indirectly, via application, e.g., to soil or other plant substrates but making uptake by the plant possible.

Suitable application methods include high or low-pressure spraying, immersion, atomizing, foaming, fogging, coating, and encrusting. Other suitable application procedures can be envisioned by those skilled in the art. In a particular embodiment, the extract of the invention is applied to the parts of the plant above ground or to the foliage of the plant by spraying e.g. by the use of mechanical sprayers. Sprayers convert a formulation of the invention which is mixed with a liquid carrier, such as water or fertilizer, into droplets. The droplets can be any size. Boom sprayers and air blast sprayers can also be used to apply formulations of the invention to pre-emerging or post-emerging crops. Air blast sprayers inject formulations of the invention mixed with a liquid carrier into a fast-moving air stream. Boom sprayers, aerial sprayers, ultra-low volume sprayers, drip irrigation, sprinkler irrigation, and foggers can also be used to apply formulations of the invention. Where the formulations of the invention are in a solid, powder or granule form, they can be applied with granule or dust application equipment. Formulations of the invention can also be applied as a fumigant to soil, plant media, plants, or plant tissues.

In another embodiment, seeds of a plant are coated with the extract of the invention (“coated seeds”). Any appropriate seed coating method known the skilled person can be used. E.g. seeds can be treated with the extract of the invention in multiple ways including, without limitation, via spraying or dripping, drenching, or pellet application. Spray and drip treatment can be conducted, for example, by formulating an effective amount of the extract in an agronomical acceptable carrier, typically aqueous in nature, and spraying or dripping the composition onto seed via a continuous treating system (which is calibrated to apply treatment at a predefined rate in proportion to the continuous flow of seed), such as a drum-type of treater. Such methods include those that can advantageously employ relatively small volumes of carrier so as to allow for relatively fast drying of the treated seed. Large volumes of seeds can be efficiently treated. Batch systems, in which a predetermined batch size of seed and signal molecule compositions are delivered into a mixer, can also be employed. Systems and apparatuses for performing these processes are commercially available from numerous suppliers. The present invention also provides a seed coated with the extract/composition of the present invention.

In another aspect, the extract or composition can be applied to the substrate of the plant (e.g. in hydroponics) or to the soil directly, e.g. by drip irrigation or drench application (soil drench). A soil drench applies the extract, optionally mixed with water, to the soil around the base of a plant so that its roots can absorb the extract.

In a specific embodiment, the extract of the present invention can be applied to a plant as provided herein alone, in combination or in a mixture with other compounds. Suitable other compounds include effective amounts of other agricultural or horticultural biologicals and/or chemicals, such as herbicides, insecticides, nematicides, molluscicides, bactericides, acaricides, fungicides, and/or plant growth regulators or fertilizers.

In yet another embodiment the invention provides a method for the manufacture of (‘or the production of’ which is equivalent wording) a composition according to the invention, comprising formulating the extract of the invention together with at least one customary agrochemical auxiliary agent. Suitable manufacturing methods are known in the art and include, but are not limited to, high or low shear mixing, wet or dry milling, drip-casting, encapsulating, emulsifying, coating, encrusting, pilling, extrusion granulation, fluid bed granulation, co-extrusion, spray drying, spray chilling, atomization, addition or condensation polymerization, interfacial polymerization, in situ polymerization, coacervation, spray encapsulation, cooling melted dispersions, solvent evaporation, phase separation, solvent extraction, sol-gel polymerization, fluid bed coating, pan coating, melting, passive or active absorption or adsorption. Customary agrochemical auxiliary agents are well-known in the art and include, but are not limited to aqueous or organic solvents, buffering agents, acidifiers, surfactants, wetting agents, spreading agents, tackifiers, stickers, carriers, fillers, thickeners, emulsifiers, dispersants, sequestering agents, anti-settling agents, coalescing agents, rheology modifiers, defoaming agents, photo-protectors, anti-freeze agents, biocides, penetrants, mineral or vegetable oils, pigments and drift control agents or any suitable combination thereof.

The following examples are set forth below to illustrate the methods, compositions, and results according to the disclosed subject matter. These examples are not intended to be inclusive of all aspects of the subject matter disclosed herein, but rather to illustrate representative methods, compositions, and results. These examples are not intended to exclude equivalents and variations of the present invention, which are apparent to one skilled in the art.

### Examples

1. Preparation of the Extract

A Clextral (France) Evolum HT 53 co-rotating and co-penetrating twin-screw extruder was used for the sunflower extract production. The extruder barrel, with a length of 1.9 m, consisted of eight modules, each 4 D in length (with D corresponding to the screw diameter, i.e., 53 mm), except for module 1, which had an 8 D length. A filter section consisting of six hemispherical dishes with perforations 1 mm in diameter was outfitted on module 7 to enable the filtrate containing the sunflower extract to be collected.

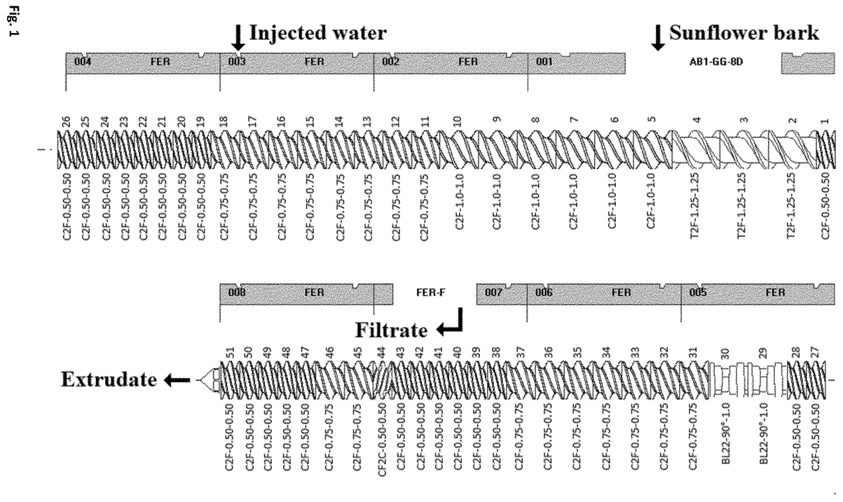

Barrel modules 2 to 6 and 8 were temperature controlled. Sunflower bark material was introduced near the first module at a 10.2 kg/h flow rate with a Coperion (Germany) K-Tron SWB-300-N gravimetric feeder. Water was injected at a 29.6 kg/h flow rate using a DKM (France) Super MD-PP-63 piston pump, corresponding to a 2.9 liquid/solid (L/S) ratio. The screw configuration that was applied is presented in FIG. 1. In particular, the bilobe paddles (BL22) in module 5 were used to favour an intimate mixing between the liquid and the solid. In addition, the reversed pitch screws (CF2C) positioned at the end of module 7, i.e., immediately downstream from the filtering sieves, were used to place pressure on the liquid/solid mixture, which was essential for the separation of liquid (i.e., the filtrate; liquid part) and solid (i.e., the extrudate; fibrous part) phases by filtration. The filtrate is used as the extract or to prepare the extract of the present invention.

The extruder screw speed was 250 rpm to avoid the clogging of the machine over time while preserving a residence time of the L/S mixture as long as possible in the separation zone (i.e., end of module 7). In addition, to maximize the extraction efficiency, the L/S ratio was chosen as high as possible (i.e., 2.9) while maintaining an effective separation of the two phases at the end of module 7. With more water, the consistency of the mixture would have been reduced, making this separation more difficult and, consequently, the extraction less efficient. The extrusion temperature was as follows: 25° C. in module 1, 80° C. in module 2, 100° C. in modules 3 to 6, and 110° C. in module 8. In particular, the 100° C. temperature in the extraction zone (i.e., modules 3 to 6) was chosen for optimizing the extraction efficiency.

2. In Vitro Arabidopsis Root Growth with Sunflower Extract

Materials and Methods

Plant Materials and Growth Conditions

Arabidopsis thaliana Col-0 seedlings were grown and observed on plastic petri dish cultured in the MS medium (Murashige and Skoog basal medium) mixed with sunflower water extract (Treatment) or not (Control).

Sunflower extract was prepared as described above and further diluted in water.

We germinated and etiolate the seeds to induce adventitious root(AR) followed Trinh HK's protocol (Trinh, Verstraeten, & Geelen, 2018).

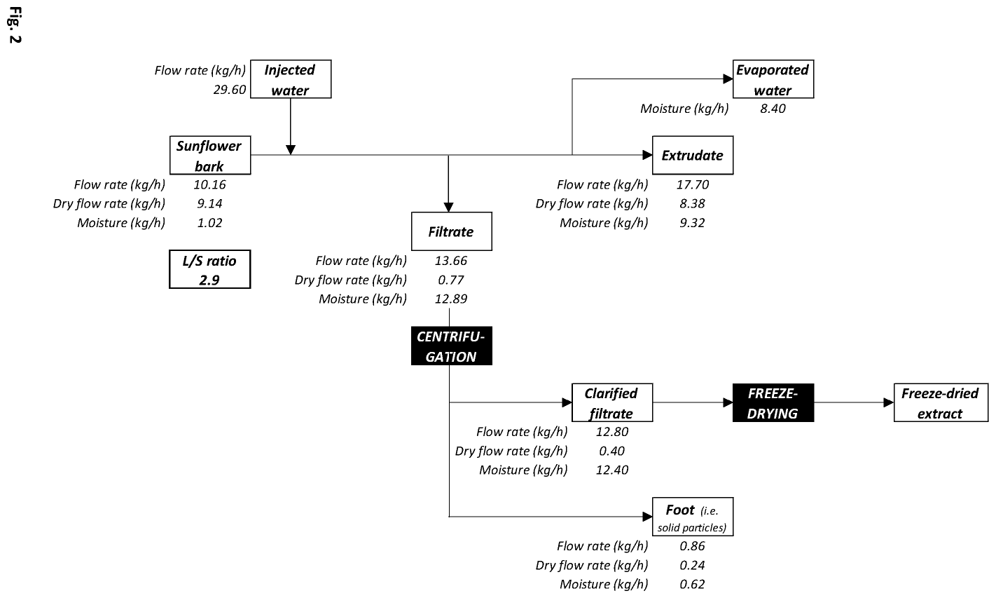

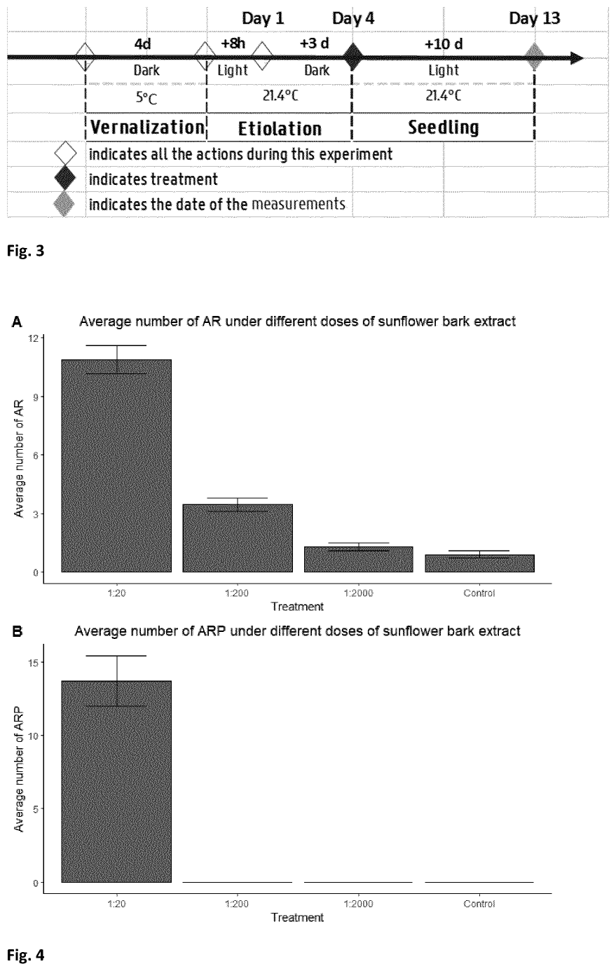

FIG. 3 illustrates experimental workflow. Arabidopsis seeds were sown on petri dishes with MS medium. The seeds were vernalized in the dark at 5° C. for 4 days before etiolation. The etiolated seedlings were transferred to petri dishes with MS medium mixed with sunflower bark extracts. Root morphology was observed after 10 days.

Extract Dilution

Freeze-dried sunflower bark extract was dissolved in water to form a stock solution, and then diluted into three doses according to the recommended concentration, 1:20, 1:200 and 1:2000, respectively (Table 1).

TABLE 1
The instruction on different doses of
sunflower bark extract and dilutions.

| Dilution | Dose | | Instruction |
|---|---|---|---|
| Stock | 73.33 | g/L | Weigh 733.33 mg of original extract in 10 ml |
| | | | dH₂O |
| 1:20 | 3.665 | g/L | dilute 2.5 ml of stock into 50 ml MS medium |
| 1:200 | 0.3665 | g/L | dilute 0.25 ml of stock into 50 ml MS medium |
| 1:2000 | 0.03665 | g/L | dilute 0.025 ml of stock into 50 ml MS medium |

Measurements

Root morphological traits were examined by digital photos at day 12 based on Table 2 under same light conditions.

TABLE 2
Measurements on Arabidopsis seedling's root.

| Abbreviation | Metric | Description |
|---|---|---|
| AR | n¹ | Adventitious root |
| ARP | n | Adventitious root primordia² |

¹n indicates for number.
²Each type of root primordia was observed within the epidermis cells

Statistics Analysis

Two-tailed Student's t-test at 0.05 alpha level was processed between treatments and control (no extract added). R package ggplot2 was used for data analysis and visualization.

Results and Discussion

1:2000 of extract promoted the largest root system area (RSA) while generating slightly more density of root hair at the middle part of every lateral root. RSA of the seedling treated by 1:200 was decreased largely with extensive root hair at the end of every single root. 1:20 stimulated the most ARs in hypocotyl.

ARP could be also considered as AR-related trait at the early stage of formation. In FIG. 4, Seedlings with 1:20 treatment produced the largest amount of both AR (mean=10.87) and ARP (mean=13.7) significantly. At the meantime, 1:200 could still stimulate moderate more of AR (mean=3.47) than control.

These results demonstrate that the sunflower bark extract stimulates the formation of adventitious routs.

3. Effect of Sunflower Extract on In Vitro Root and Shoot Regeneration

3.1. Tobacco Leaf Disk Assay

Material & Methods

Petri-dishes were filled with 10 ml ½ Murashige & Skoog medium+30 g/l sucrose and 7 g/l agar-agar and 0-100-1000 mg/l sunflower extract (prepared as described before). Per petri dish, 20 leaf disks (with and without vein) of 5 mm diameter were punched out of tobacco leafs and put upside down on the medium. After 3 weeks the presence of adventitious roots and callus as well as leaf disk expansion was assessed.

Results

The mock treatment did not induce ARs. The sunflower extract induced ARs on the tobacco leaf disks, used at a concentration of 1000 mg/l. In Table 3 the data are presented, together with means and SD. No shoots were produced.

TABLE 3
Adventitious root induction on tobacco leaf disks
Tobacco leaf disc bioassay (3 w)

| | | Sunflower | Sunflower |
|---|---|---|---|
| | | extract | extract |
| | Control | (100 mg/L) | (1000 mg/L) |
| Mean root number | 0 | 0.0 | 1.8 |
| SD | 0 | 0.0 | 1.8 |
| Reacting explants % | 0 | 0% | 60% |
| Mean root number/reacting | 0 | 0.0 | 3.0 |
| explants | | | |
| SD | 0 | 0.0 | 1.1 |

3.2. Sugarcane Bioassay

Material & Methods

Glass jars of 350 ml were filled with 100 ml Murashige & Skoog medium+30 g/l sucrose and 7 g/l agar-agar and 0-100-1000 mg/l sunflower extract. Per jar, 5 uniform shoot explants were transferred to the medium (two jars per treatment=10 explants). After 3 weeks the presence of adventitious roots was assessed.

Results

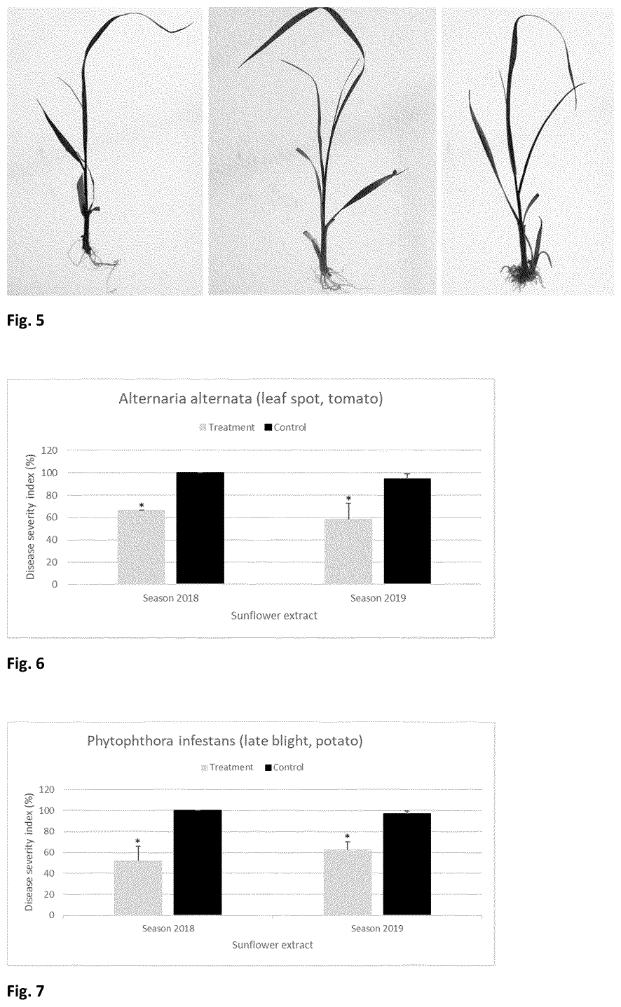

The control treatment showed 70% rooting with 3.3 ARs per reacting plantlet. But when 100 mg/l sunflower extract was applied, 100% plants rooted (table 4) and the number of roots increased with a factor 4 (FIG. 5).

TABLE 4
Adventitious root induction on sugarcane shoots after 3 weeks
Sugarcane Bioassay (3 w)

| | | Sunflower | Sunflower |
|---|---|---|---|
| | | extract | extract |
| Adventitious roots per plant | Control | (100 mg/L) | (1000 mg/L) |
| Mean root number | 2.3 | 4.6 | 13.3 |
| SD | 1.9 | 1.2 | 1.6 |
| Reacting explants (%) | 70% | 100% | 100% |
| Mean root number/reacting | 3.3 | 4.6 | 13.3 |
| explant | | | |
| SD | 1.4 | 1.2 | 1.6 |

3.3. Plectranthus Bioassay

Material & Methods

Glass jars of 350 ml were filled with 100 ml Murashige & Skoog Mod. 3B including vitamins (Mod.3B) medium+30 g/l sucrose and 7 g/l agar-agar and 0-100-1000 mg/l sunflower extract. Per jar, 5 uniform nodal shoot explants were transferred to the medium (two jars per treatment=10 explants). After 3 weeks the presence of adventitious roots was assessed.

Results

The mock treatment showed 90% rooting with 4.3 ARs per reacting plantlet. When 100 mg/l sunflower was applied, 100% plants rooted (Table 5), and the number of roots increased with a factor 3.

TABLE 5
Adventitious root induction on Plectranthus shoots after 4 week
Plectranthus rooting bioassay (4 w)

| | | Sunflower | Sunflower |
|---|---|---|---|
| | Control/non- | extract | extract |
| Adventitious roots per plant | treated | (100 mg/L) | (1000 mg/L) |
| Mean root number | 3.85 | 10 | 12.9 |
| SD | 2.6 | 4.4 | 2.1 |
| Reacting explants % | 90% | 100% | 100% |
| Mean root number/reacting | 4.3 | 10 | 12.9 |
| explants | | | |
| SD | 2.4 | 4.4 | 2.1 |

3.4. General Conclusion

These data demonstrate that the sunflower extract stimulates the formation of roots in different plants.

4. Biocidal Activity of Sunflower Extract to Control Plant Diseases Using Foliar Applications

The biocidal activity of an organic extract derived from waste stream (i.e. bark) of sunflower stems was investigated against four important widespread plant pathogens including Phytophthora infestans (late blight of potato), Botrytis cinerea (gray mold of tomato), Blumeria graminis (powdery mildew of wheat) and Alternaria alternata (leaf spot of tomato) under greenhouse conditions.

Method & Results

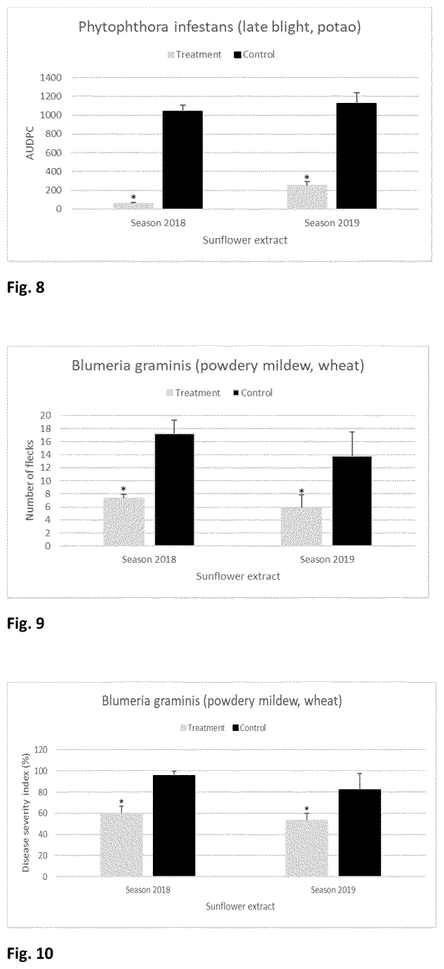

Detached leaf assay of tomato and potato was used for pathogens A. alternata and P. infestans respectively:
Foliar spraying of tomato and potato plants with 1% dilution (1 g/100 ml) of sunflower extract (after 6-7 weeks of growing), 24 h before inoculation in order to take protective mode of action into account;
Removing leaves 24 h after spraying (3 compound leaves per replicate);
Inoculating leaflets with a single 15 μL droplet of spore suspension of pathogens (10*5 spore/ml) at the center of each leaflet and keeping them under appropriate conditions at plant growth chamber.
Assessing disease incidence 5-7 days after inoculation on treated and control leaflets according to an arbitrarily grading scale and converting to disease severity index (DSI) on a percentage basis where; DSI (%)=Σ(class frequency×score of rating class)/(total number of leaflets)×(maximal rating class)×100 (FIGS. 6 and 7).
To quantify the disease severity over time, the area under the disease progress curve (AUDPC) was calculated for potato plants during 32 days of infection (FIG. 8) according to the equation: AUDCP=Σ[(Xi+Xi+1)/2]ti, where Xi and Xi+1 are severity on date i and date i+1, respectively and ti is the number of days between date i and date i+1.

Whole plant assay was used for pathogens B. cinerea and B. graminis as following: For wheat:
Foliar spraying of wheat plants with 1% dilution of sunflower extract (after 2 weeks of growing), 24 h before inoculation in order to take protective mode of action into account;
Inoculating whole plants by spraying spore suspension of B. graminis (10*5) and keeping plants under appropriate conditions in the greenhouse.
Assessing disease intensity based on disease symptoms (pathogen white flecks) (FIG. 9) and calculating disease severity 20 days after inoculation as described above (FIG. 10).

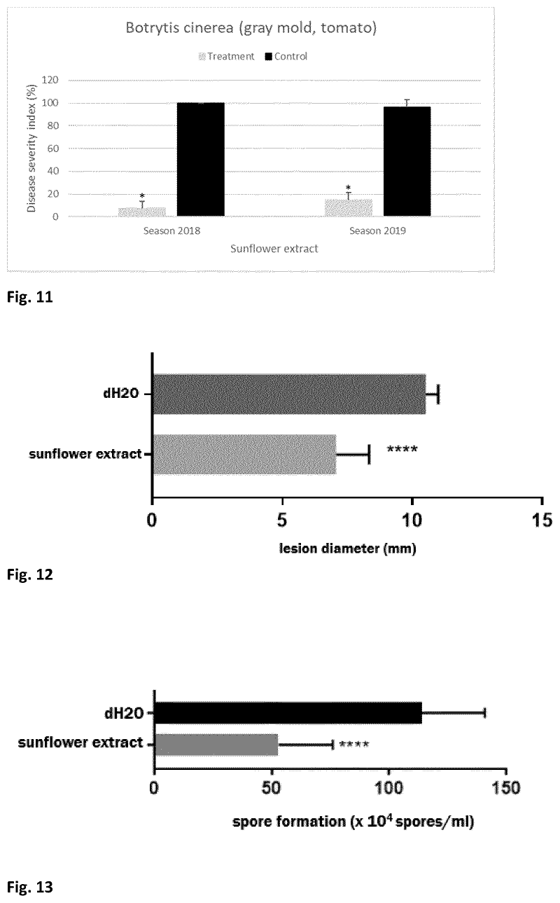

For tomato:
Removing composed leaves (3 of each plant) with 10 mm petiole stubs on stems and applying with 10% dilution of concentrated extract (after 5-6 weeks of growing).
Inoculating pruning wounds (2 h after treatment) with spore suspension of B. cinerea (10*4) and keeping under appropriate conditions in the greenhouse.
Assessing disease severity 12 days after inoculation as previously described (FIG. 11).

In our experiments, based on DSI, sunflower extract significantly reduced the development of disease compared to the control treatments (p-value<0.05). In addition, in wheat plants treated with sunflower extract, disease symptoms (white flecks) were not or less present in the newly developed leaves compared to control plants (FIG. 9), indicating that the plant defense mechanism was activated.

5. Induced Resistance Against a Necrotrophic Fungal Pathogen Triggered by Application of the Sunflower Extract in the Crop Pathosystem Canola—Botrytis cinerea

Methods

Induced resistance triggered by leaf application of the sunflower extract in the pathosystem canola—Botrytis cinerea. Canola plants (cv Westar) were grown in soil at a dark/light regime of 12 h/12 h, a light intensity of 100 μM, a temperature of 21° C. and relative humidity of 70%. One cotelydon of 11-days old plants was sprayed with the sunflower extract (25 mg/ml) or distilled water (negative control) until run-off. Three days later inoculation of the other (non-treated) cotelydon was done by application of 2 spots/cotelydon of 5 μl of a spore suspension (1*10⁷ spores/ml in ½ PDB) of Botrytis cinerea B05.10. Plants were grown for another 3 days under the same conditions as mentioned before but in an incubation box allowing maximal relative humidity favouring disease progression. Disease severity was evaluated by measuring de lesion diameter. Bars represent average lesion diameter of 12 plants (****=p≤0.01, 1-way Anova).

Results

Application of the sunflower extract resulted in a significant reduction of lesions caused by infection of the fungus Botrytis cinerea when applied on cotelydons of canola plants (FIG. 12). Since extract application and pathogen inoculation are done on different cotelydons of the same plant, the observed reduction does not result from direct antagonistic (or direct) effect of the sunflower extract on the pathogen, but from an induced resistance in the plant triggered by the sunflower extract.

6. Induced Resistance Against a Biotrophic Oomycete Pathogen Triggered by Application of the Sunflower Extract in the Model Pathosystem Arabidopsis thaliana—Hyaloperonospora arabidopsidis

Methods

Induced resistance triggered by leaf application of the sunflower extract in the pathosystem Arabidopsis thaliana—Hyaloperonospora arabidopsidis. Arabidopsis plants (ecotype Col0) were grown in soil at a dark/light regime of 12 h/12 h, a light intensity of 100 μM, a temperature of 21° C. and relative humidity of 70%. Leaves of 9-days old plants were sprayed with the sunflower extract (25 mg/ml) or distilled water (negative control) until run-off. One day later inoculation of the leaves was done by spraying the leaves until run-off with a spore suspension (6*10⁴ spores/ml in H2O) of Hyaloperonospora arabidopsidis Noks1. Plants were further grown for another 7 days under the same conditions as mentioned before (but at 17° C.) and in an incubation box allowing maximal relative humidity favouring disease progression. Disease severity was evaluated by quantifying the amount of newly produced pathogen spores on batches of 15 plants. Bars represent average spore formation of 7 batches (each representing 15 plants (****=p≤0.01, 1-way Anova).

Results:

Application of the sunflower extract resulted in a significant reduction of spore formation caused by infection of the oomycete Hyaloperonospora arabidopsidis when applied on leaves of Arabidopsis plants (FIG. 13).

7. Induced Resistance Against a Hemibiotrophic Bacterial Pathogen Triggered by Application of the Sunflower Extract in the Model Pathosystem Arabidopsis thaliana—Pseudomonas syringae

Methods

Induced resistance triggered by leaf application of the sunflower extract in the pathosystem Arabidopsis thalinana—Pseudomonas syringae. For preparation of the Pseudomonas syringae inoculum, the bacterial strains were grown at 28° C. on King's B medium, containing 25 μg/ml rifampicine. Before plant infiltration, bacterial cultures were washed and resuspended in sterile water to a concentration of 10⁶ CFU/ml. Arabidopsis thaliana (ecotype Col0) plants were grown in soil at a dark/light regime of 12 h/12 h, a light intensity of 100 μM, a temperature of 21° C. and relative humidity of 70%. Leaves of 5-week old plants were sprayed with the sunflower extract (25 mg/ml and 75 mg/ml) or distilled water (negative control) until run-off. Three days later leaves were infiltrated with a blunt-end 1 ml syringe at the abaxial side with the P. syringae suspension. After infiltration, plants were further grown for another 7 days under the same conditions as mentioned before but in an incubation box allowing maximal relative humidity favouring disease progression. Bacterial growth was measured 1, 2, 3 and 4 after infiltration by evaluating the number of colony forming units (CFUs) in leaf tissue extracts, following the procedure described by Katagiri et al., 2002 (The Arabidopsis Thaliana-Pseudomonas Syringae Interaction. The Arabidopsis Book. 1, e0039). Each time-point represents mean (±SEM) of 5 leave samples consisting of 4 pooled leaf disks of 2 independent replicate plants. (*=p≤0.05, **=p≤0.01, 1-way Anova at the different time-points).

Results

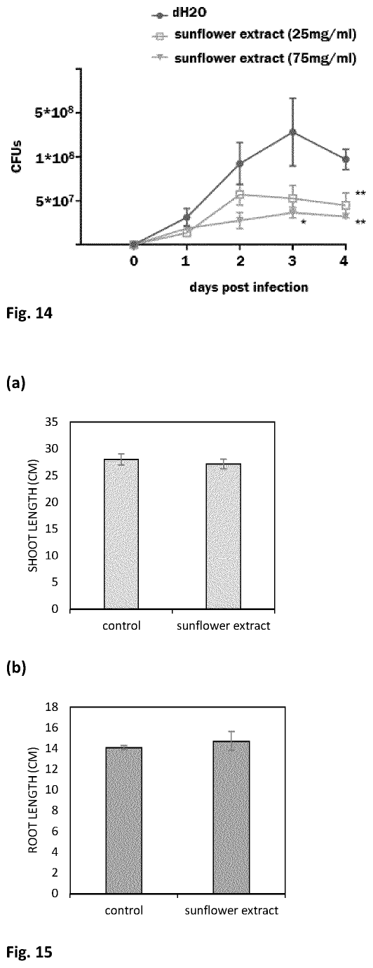

Application of the sunflower extract resulted in a significant reduction of proliferation by infection of the bacterium Pseudomonas syringae when applied on leaves of Arabidopsis plants (FIG. 14).

8. Induced Systemic Resistance Against Nematodes Methods

Nematode cultures—Root-knot nematode Meloidogyne graminicola was extracted from infected Echinocloa crus-galli roots grown in potting soil at 25° C. Roots were washed until most soil was removed, after which they were cut into short fragments (with special care taken to cut open any visible root galls). The cut material was put in 200 μm pore diameter sieves which were put into a tap water bath at room temperature for three days. The water was then poured over a 20 μm mesh sieve to collect the nematodes. The sieve surface was washed with approximately 50 ml of non-demineralized water, which was collected into a beaker before it could seep through the sieve. The number of J2 (second stage juvenile) nematodes in five 100 μl samples taken from the nematode suspension was counted under a stereo microscope and averaged to determine inoculum concentration.

Rice (Oryza sativa) growth—Seeds (cultivar ‘Nipponbare’) were germinated on wet tissue paper at 30° C. in the dark for three days, followed by transfer to individual PVC tubes containing SAP (Reversat et al., 1999). SAP (sand-absorbent polymer) is a mixture of fine silica sand and ultra-absorbent acrylic copolymer (AquaPerla, DCM, Grobbendonk, Belgium) in a ratio of 1 kg sand to 1.5 g of dry copolymer.

Before use, each tube was washed in soapy water and dried in an oven at 70° C. for two days. The tubes were placed inside plastic boxes in a completely randomized manner to minimize environmentally induced bias and transferred to a growth chamber at 28° C. with 16 hours of light. The first two days after transfer, the tubes were covered with a polyethylene film (Saran Film, Dow Chemicals, Midland, USA) to prevent excessive evaporation. Seedlings were irrigated three times per week with 8 ml of Hoagland solution (Hoagland, 1938).

Treatment with extract and inoculation—Fourteen-day old rice plants were foliarly sprayed with the sunflower extract (7 ml/plant+0.2% Tween20 as surfactant). Control plants were mock-treated with water+0.2% Tween20. Per treatment, 6 individual plants were used (n=6). One day after treatment, plants were inoculated with nematodes by introducing 250 J2 next to the root system using a micro pipette.

Evaluation—Plants were harvested 14 days after inoculation. The plants were phenotyped by measuring the shoot and root length with a ruler. Root systems were then stained in acid fuchsine as described in (Byrd et al., 1983) and left to destain in glycerol containing 1 ml/l fuming HCl for approximately ten days. The number of root galls formed by M. graminicola was then counted using a binocular microscope.

Statistical analysis—After confirming normality and homoscedasticity of the data a Duncan's Multiple Range test was executed with α=0.05.

Results

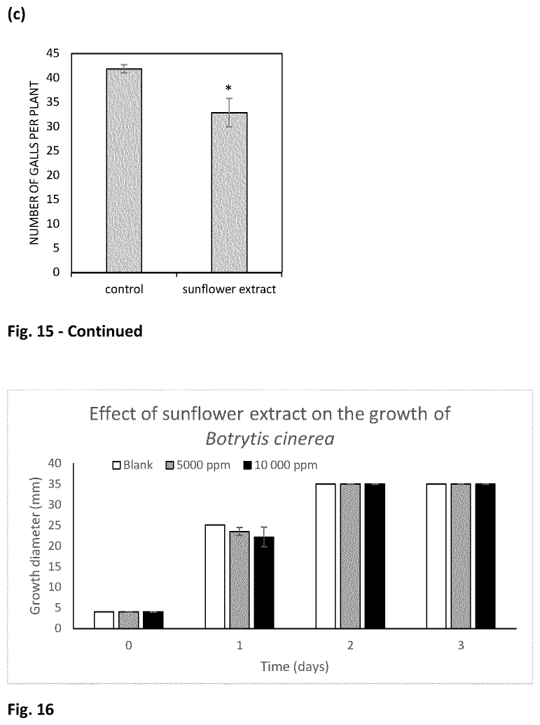

In this experiment, the induced effect against root-knot nematode Melodoigyne graminicola in rice (Oryza sativa cv. Nipponbare) was evaluated by spraying the extract on rice shoots 24 h before nematode inoculation (250 J2 per plant) on the roots. Root galls were counted 14 days later and the plant length was measured (n=6). The extract is well-tolerated by the plants, as there are no observable negative effects on root length and shoot height (FIGS. 15a and b). The results show that foliar application of the sunflower extract leads to induced systemic plant defense activation against root-knot nematodes, with a significant reduction in nematode-induced galls per plant (FIG. 15c).

9. Effect of Sunflower Extract on Fungal Growth

Materials and Methods

Sunflower extract was tested at 5000 and 10 000 ppm.

Botrytis cinerea was grown on potato dextrose agar.

The fraction was tested in triplicate in Petri dishes of 35 mm and the size of the mycelial plug at the start was 4 mm. Mycelial growth was assessed by measuring the growth diameter at different time points until the mycelium in the control plates had reached the edge of the Petri dish. Plates were inoculated at 24° C.

Results

No inhibiting effect was observed on mycelial growth by direct application of the sunflower extract to the fungus (FIG. 16). These results demonstrate that the extract of the present invention has no direct antifungal activity.

### REFERENCES

Azania A. A. P. M. et al. Allelopathy Journal 11 (1): 1-20 (2003) Allelopathic Plants. 7. Sunflower (Helianthus annuus L.)
Subhash Babu, D. S. Rana, G. S. Yadav, Raghavendra Singh, and S. K. Yadav (2014) International Journal of Agronomy 179(2): 123-126
Marechal, V.; Rigal, L., 1999. Characterization of by-products of sunflower culture—commercial applications for stalks and heads. Industrial Crops and Products, 10 (3): 185-200
Reversat, G. et al. (1999) ‘Use of a mixture of sand and water-absorbent synthetic polymer as substrate for the xenic culturing of plant-parasitic nematodes in the laboratory’, Nematology, 1(2), pp. 209-212.
Trinh, H. K., Verstraeten, I., & Geelen, D. (2018). Chapter 7 on Intact Arabidopsis Hypocotyls, 1761, 95-102.
Hasem A. et al., Polymer-PlasticsTechnology and Engineering, 45:135-141, 2006.
Leather et al., Weed Sceince, vol. 31: 37-42, 1983.
Nisar S. et al., J. Phytol. Res. 2(2), p 145, 1989.
Singh R L. et al., Journal of Crop Science and Biotechnology, vol 20, no 1, p 45-60, 2017.

1. Use of an extract for promoting root formation in plants and/or for inducing and/or stimulating an immune response in plants, wherein the extract is a water extract obtained from a depithed stem of a plant from the genus Helianthus, in particular Helianthus annuus L., and wherein the extract is applied on a plant or part(s) thereof, or in the growth medium of a plant.

2. Use according to claim 1, for promoting the growth of adventitious roots of a plant.

3. Use according to claim 1, for inducing resistance to biotic stress in plants.

4. Use according to claim 3, wherein said resistance is induced against infections by bacteria, fungi, nematodes and/or oomycetes.

5. Use according to claim 4, wherein the bacteria are selected from the group consisting of the genera Pseudomonas, Ralstonia, Rhizobium, Agrobacterium, Xanthomonas, Erwinia, Xyllela, Dickeya, Pectobacterium, Streptomyces, Clavibacter, Candidatus Liberibacter, Bacillus, Corynebacterium and Burkholderia.

6. Use according to claim 4, wherein the fungi are selected from the group consisting of the genera Magnaporthe, Botrytis, Puccinia, Fusarium, Blumeria, Mycosphaerella, Colletotrichum, Ustilago, Phakopsora, Alternaria, Sclerotinia, Cladosporium and Rhizoctonia.

7. Use according to claim 4, wherein the nematodes are selected from the group consisting of the genera Meloidogyne, Heterodera, Globodera, Pratylenchus, Aphelenchoides, Xiphinema, Radopholus, Bursaphelenchus, Rotylenchulus, Nacobbus, Longidorus, Ditylenchus and Trichodorus

8. Use according to claim 4, wherein the oomycetes are selected from the group consisting of the genera Pythium, Phytophthora and Peronosporaceae.

9. Use according to anyone of claims 1 to 8; wherein said extract is dried or freeze-dried.

10. Use according to anyone of claims 1 to 7; wherein the extract sprayed on the plant, watered on the plant, added to the substrate or soil in which the plant is growing, or used as a seed coating.

11. Use according to claim 1 or 10; wherein said extract is applied to the leaves of a plant by spraying, immersion, atomizing, foaming, fogging, coating, or encrusting

12. A plant seed coated with a coating composition comprising an extract obtained from a depithed stem of a plant from the genus Helianthus, in particular Helianthus annuus L.

13. Use according the anyone of claims 1 to 11; wherein the extract is part of a composition further comprising an agriculturally and/or horticulturally acceptable excipient.

14. A process for the preparation of an extract obtained from a depithed stem of a plant from the genus Helianthus, said process comprising at least the following steps:
(a) providing stems of a plant of the genus Helianthus;
(b) separating the pith from the bark of said stems of step (a);
(c) extruding, blending or mixing the bark material obtained from step (b), optionally in the presence of a buffering agent or solvent;
(d) isolating the liquid fraction obtained from step (c); and
(e) obtaining said extract;
wherein during said process, the temperature is raised to at least 100° C.

15. The process according to claim 14, wherein the L/S (liquid/solid) ratio is between 2 and 5.

16. An extract obtained by the process of claim 14 or 15.
